(19) United States
(12) Patent Application Publication
(10) Pub. No.: US 2011/0193518 A1
(43) Pub. Date: Aug. 11, 2011

(54) BATTERY OVERRIDE

(76) Inventors: James Wright, San Jose, CA (US); Wang Ke Chun, Ningbo City (CN); Xia Guan Hao, Ningbo City (CN); Zhao Ding, Ningbo City (CN)

(21) Appl. No.: 13/023,956

(22) Filed: Feb. 9, 2011

Related U.S. Application Data
(60) Provisional application No. 61/303,062, filed on Feb. 10, 2010.

(51) Int. Cl. H01M 10/46; H02J 7/00

(52) U.S. Cl. 320/101; 320/134

(57) ABSTRACT

A battery system is described. In one embodiment, the battery system uses a battery override. In another embodiment, the battery system has an integrated power management system having a charge controller and an inverter integrated into a single device.

### RELATED APPLICATIONS

This application claims the benefit of U.S. Provisional Patent Application No. 61/303,062, filed on Feb. 10, 2009, the contents of which are hereby incorporated by reference.

### TECHNICAL FIELD

The present invention relates generally to battery systems, and, more particularly, to charge controllers of battery systems for providing a battery override.

### BACKGROUND

An electrical battery is a combination of one or more electrochemical cells, which are used to convert stored chemical energy into electrical energy. The battery has become a common power source for many household and industrial applications. Batteries provide energy storage, and are required for any remote, standalone, or back-up renewable energy system. Batteries may be used once and discarded, or recharged for years as in standby power applications. Larger batteries provide standby power for various applications. Batteries accumulate energy generated by various renewable energy devices, such as photovoltaic (PV) modules, wind, or other power input sources. This stored energy runs the household at night or during periods when energy output exceeds energy input. Batteries can be discharged rapidly to yield more power than the charging source can produce by itself, so pumps or motors can be run intermittently. For personal safety and good battery life expectancy, batteries need to be treated with some care, and possibly be recycled at the end of their life.

A wide variety of differing chemicals can be combined to make a functioning battery. Some combinations are very low cost, but they have very low power potential. These types of batteries may include lithium-ion batteries, lead-acid batteries, or the like.

Solar batteries store direct current (DC) energy generated from your solar system for later use when you need it. The use of deep cycle batteries is more common in off-grid solar systems, but they can also be used in some grid connected solar power systems. Batteries used in solar systems are specially designed with deep-cycle cells, which are much less susceptible to degradation due to cycling. Deep cycle batteries are best for applications where the batteries are regularly discharged. The three types of batteries that are most commonly used in solar electric systems are flooded lead acid, absorbed glass mat sealed lead acid (AGM), and gelled electrolyte sealed lead acid (Gel); although other types of batteries may be used. Typically, batteries capacities are shown in amp hours (Ah). The battery capacity is calculated as Watt Hours=Volts*Amp Hours. For longest life expectancy of the battery, typically deep-cycle cells discharge to about 50% before being recharged.

Rechargeable large-capacity batteries use deep-cycle type batteries, such as we-cell and gel-cell batteries. Systems using these rechargeable batteries depend upon battery power, and thus, benefit from knowing the actual state-of-charge (SOC) of the battery. Otherwise, if the battery's charge is depleted without sufficient warning, a user may be stranded and unable to reach a power source to recharge the battery. Since a rechargeable battery may be damaged by excessive discharge or by under-charging, accurate monitoring of a battery's SOC is important. Accurate monitoring allows the battery to be recharged before the SOC is excessively low and avoid under-charging, thereby increasing the life of the battery. Batteries typically have a manufacturer-specified charge capacity (CCAP) that represents the battery's total charge capacity when fully charged, whereas the SOC represents the actual amount of charge remaining in the battery.

Conventional charge controllers can be used to accurately monitor the SOC, and when the SOC reaches a specified threshold, referred to as depth of charge or depth of discharge (e.g., 40-50% for lithium ion), the charge controller cuts the current provided by the battery by decoupling the battery from the rest of the circuit in order to protect the battery life. Conventional charge controllers can monitor the SOC using various techniques, such as detecting the specific gravity of the battery electrolyte, measuring the terminal voltage of the battery, and/or measuring and tracking over time the charge drawn from and supplied by the battery. Another conventional method monitors an accurate SOC of a battery by compensating for varying current loads and changing temperature conditions, such as described in U.S. Pat. No. 6,656,919. This reference also describes various methods of monitoring the SOC, as well as providing an SOC indicator, including a display having an array of illuminable elements for indicating the relative SOC of the battery.

However, there are certain conditions when a user of the battery system may care more about maintaining power provided by the battery than decreasing the life of the battery. In these conditions, the depth of draw of the battery being set at 50% would allow the user to only user 50% of the actual charge of the battery, and the charge controller would prevent the user from accessing additional charge that exists on the battery for the sake of protecting the battery. For example, a user may be in a power outage situation, caused for a variety of reasons, such as storms, earthquakes, accidents, and grid failures, where the user may not access the remaining charge on the battery because the charge controller disconnects the battery to prevent damage to the battery in an effort to not shorten the battery's life. Regardless of the reason for the condition, the charge controller limits the power to the specified depth of draw and prevents access the remaining charge on the battery.

### BRIEF DESCRIPTION OF THE DRAWINGS

The present disclosure is illustrated by way of example, and not by way of limitation, in the figures of the accompanying drawings.

FIG. 1 illustrates one embodiment a system including a charge controller with a battery override for overriding a depth of draw of a battery system.

FIG. 2A illustrates one embodiment of the battery system of FIG. 1 having a charge controller with the battery override.

FIG. 2B illustrate another embodiment of a battery system having an integrated power management system.

FIG. 3 is a flow diagram of one embodiment of a method of overriding a depth of draw threshold of a battery system.

FIG. 4 illustrates a diagrammatic representation of a machine in the exemplary form of a computer system for battery override according to one embodiment.

FIG. 5 illustrates one embodiment of a battery system having a handle and wheels.

FIG. 6 illustrates another embodiment of a battery system having a handle.

### DETAILED DESCRIPTION

A battery system is described. In one embodiment, the battery system uses a battery override. In another embodiment, the battery system has an integrated power management system having a charge controller and an inverter integrated into a single device. The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in a simple block diagram format in order to avoid unnecessarily obscuring the present invention. Thus, the specific details set forth are merely exemplary. Particular implementations may vary from these exemplary details and still be contemplated to be within the spirit and scope of the present invention.

References in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

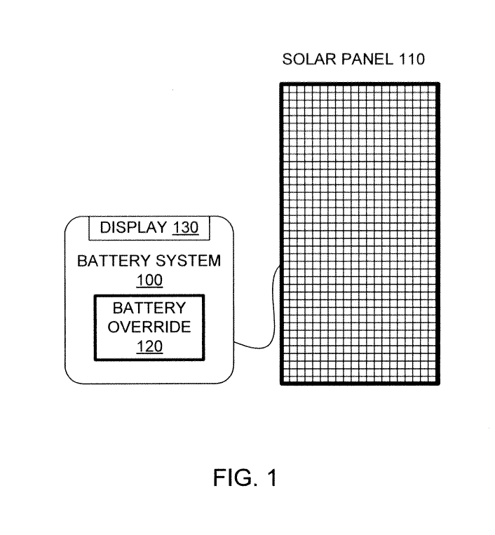

FIG. 1 illustrates one embodiment of a battery system 100 and a photovoltaic solar panel 110. The battery system 100 includes a battery override 120, as described in more detail herein, and a display 130. The battery system 100 is coupled to the photovoltaic solar panel 110 by a cable, and the panel can be placed on a roof of a house, in the yard, or anywhere where there is good exposure to the sun. The battery system may be transportable, allowing a user to put the battery system 100 in a vehicle for transporting the battery system 100 to a location to be used as a portable power source. In some embodiments, the battery system 100 may be a large battery system that is installed in one location, such as in a storage closet or basement of a building to provide back-up power in the case of an outage, for example. The battery system 100 may include one or more battery cells that can be charged and discharged. In one embodiment, the battery system 100 includes one or more deep-cycle batteries, such as sealed lead-acid batteries, lithium ion batteries, or other types of deep-cycle batteries as would be appreciated by one of ordinary skill in the art having the benefit of this disclosure. The battery system 100 uses the photovoltaic solar panel 110 to charge the battery storage of the battery system 100. It should be noted that although the depicted embodiment uses the photovoltaic solar panel 110, in other embodiments other power sources could be used to charge the battery system 100. For example, in one embodiment, the battery system 100 can be plugged into a wall or a 12 V source, such as a power outlet of a vehicle, when a quick charge is needed, or when the photovoltaic solar panel 110 is unable to generate power from the sun.

The battery system 100 uses a charge controller to maximize the life and effectiveness of the battery system 100. Charge controllers are also referred to as charge control systems and battery management systems (BMS). The charge controller is an electronic device that manages the battery system 100, such as by monitoring its state of charge (SOC), protecting the battery system 100, controlling the battery system's environment, balancing battery cells, and calculating secondary data, such as the number of charges, discharge times, and other data that can be reported to the user or a third party, such as a manufacturer of the battery cells. The charge controller can monitor the state of the battery, such as the voltage (total voltage, voltage of periodic taps, and/or voltages of individual cells), temperature (average temperature, air intake temperature, air output temperature, and/or temperatures of the individual cells, actual SOC, depth of discharge or depth of draw (DOD), which indicates the charge level of the battery, state of health (SOH), which is a measurement of the overall condition of the battery, air flow, current (such as current in and out of the battery or batteries), or the like. The monitoring algorithms can be implemented in hardware, firmware, software, or any combination thereof within the electronic device. The battery system 100 also includes a display 130 upon which one or more of these monitored items can be displayed to the user. For example, the display 130 may display the amount of charge remaining in the battery (e.g., such as a percentage of charge remaining), and/or a time remaining until a recharge is needed. The display 130 allows the user to be informed of the amount of charge remaining in the battery system 100. In one embodiment, the display 130 is a Liquid Crystal Display (LCD). In other embodiments, other types of displays can be used as would be appreciated by one of ordinary skill in the art having the benefit of this disclosure.

Unlike conventional battery systems, the battery system 100 includes a battery override 120 that allows a user to manually override any protection mechanisms used by the charge controller to protect the battery, such as mechanisms used by the battery to prevent the battery system 100 from discharging below a specified depth of draw threshold. For example, there may be circumstances when the user wishes to use more charge from the battery than to protect the life expectancy of the battery, and thus, can activate the battery override 120, allowing the battery system 100 to continue providing power for the user.

In one embodiment, when the user activates the battery override 120, the battery system 100 can update the display 130 to reflect an updated capacity of the battery. For example, a battery system having a depth of draw threshold set to 50% shows 100% charge when the battery system is full and decreases until 0% when the depth of draw is 50%, even though the battery system still has 50% charge remaining in the battery. During normal conditions, the depth of draw threshold set at 50%, for example, protects the battery system. However, in certain circumstances, such as in the case of an emergency, the user can activate the battery override 120 to continue to extract power from the battery system 100. The battery system 100 can calculate a new depth of draw threshold, such as 5% or 10%, for example, and update the percentage of charge remaining based on the adjusted depth of draw threshold. The battery override 120 can also track and send to the display 130 the number of times that the battery override 120 has been activated, as well as an indication that the battery system 100 is in an override mode. This allows the user to decide whether to exceed the specified or recommended depth of draw threshold.

In one embodiment, the battery system 100 and the photovoltaic solar panel 110 can be used in place of, or addition to traditional gasoline or diesel generators. However, regardless of the power source used, the battery system 100 can operate without using fuel, adjusting choke controls, pulling a cord to get the generator started, or storing flammable and smelly fuels. The battery system 100 may be activated by the push of a button. When using the photovoltaic solar panel 110 or wind turbine, for example, the battery system 100 uses energy from the sun or wind to charge the battery system 100. The battery system 100, in comparison to conventional systems, can provide a quieter system than conventional generators, since the solar generator is virtually noise free. For example, the noise of the battery system 100 may be limited to noise caused by internal fans that may turn on periodically to circulate air through the system's power inverter. Furthermore, the battery system 100 can be used indoors because there are no emissions, since the internal batteries are sealed. In one embodiment, the battery system 100 can be packaged to be transportable and may include one or more handles to allow one or more people to carry the battery system 100. In another embodiment, the battery system 100 is a designed for non-portable, semi-permanent, or permanent applications, such as for a primary or secondary power source of a house or building.

In one embodiment, the battery system 100 includes thousands of total watt-hours of storage, such as, for example, 1320 total Watt-hours. The battery system 100 can be used for daily or sporadic usage. In one embodiment, the photovoltaic solar panel 110 is a 30-watt solar panel. Alternatively, other types of solar panels may be used in connection with the battery system 100.

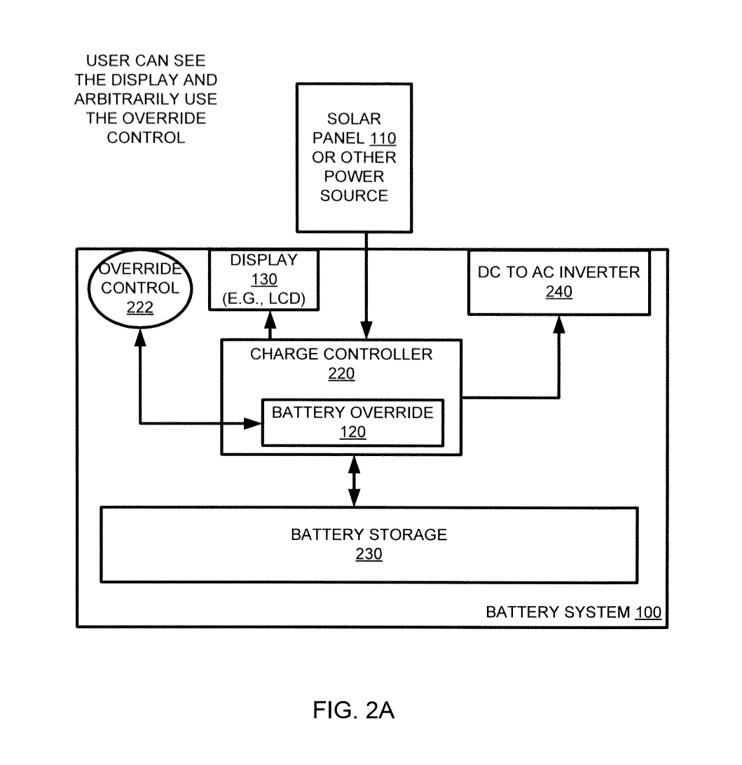

FIG. 2A illustrates one embodiment of the battery system 100 of FIG. 1 having a charge controller 200 with the battery override 120. The battery system 100 in FIG. 2A includes a charge controller 220, battery storage 230, the display 130, an override control 222, and a direct current (DC) to alternating current (AC) inverter 240. Similar reference labels designate similar components as described above with respect to FIG. 1.

As described above, the battery system 100 is couple to the photovoltaic solar panel 110 or other power input source to charge the battery storage 230. The battery storage 230 may include one or more battery cells. The battery system 100 also includes the DC to AC inverter 240 to convert to convert the DC current supplied by the battery storage 230 to an alternating current that is supplied to the electronic device (e.g., user's electrical appliance). The inverter 240 is an electrical device that converts the DC provided by the battery storage 230 to an electrical appliance that is plugged into the battery system 100. The inverter 240 can convert the DC to AC at any required voltage and frequency with the use of appropriate transformers, switching, and control circuits. The functionality and configurations of inverters would be appreciated by one of ordinary skill in the art, and thus, additional description regarding the functionality and configuration of inverters has not been included. In one embodiment, the inverter 240 is a 2500-Watt AC sine wave inverter, and can support surges of up to 5000 Watts. Alternatively, the inverter 240 may be other types of inverters and can support surges of other values as would be appreciated by one of ordinary skill in the art having the benefit of this disclosure.

In the depicted embodiment, the battery system 100 includes an override control 222, such as an override button, an override switch, or other input mechanism that allows a user to activate the battery override 120 in the charge controller 220. In one embodiment, the override control 222 sends an override control signal to the charge controller 220 to activate the override control 120. As described above, the charge controller 220 can monitor various aspects of the battery system 100, including the remaining charge in the battery storage 230. When the charge controller 220 detects that the remaining charge meets or exceeds a depth of draw threshold, the charge controller 220 cuts the current provided to the user's appliance through the inverter 240. The battery override 120, when activated, allows additional functionality by the charge controller 220. For example, when activated, the battery override 120 allows the charge controller 220 to initiate a sequence of operations, such as performed by hardware, firmware, software, or any combination thereof. The sequence of operations may include setting a new depth of draw threshold, recalculating the remaining charge, such as a percentage of remaining charge, and displaying the updated remaining charge on the display 130. The battery override 120 may also update the display 130 to indicate that the battery system 100 is in an override mode. The battery override 120 may also track the number of times that the battery override 120 has been activated. The battery override 120 can also display the number of times activated so that the user can know how many times he or she has activated this feature. The battery manufacture may indicate how many times the battery storage 230 can be discharge past an initial, default depth of draw (e.g., 40-50%) before affecting the useful life of the batteries. For example, the charge controller 220 can be programmed to allow the user to use the battery override a finite number of times (e.g., 5 times), and either prevents the user from further use of this feature, or alternatively, notifies the user via the display 130 that they have exceeded the recommended number of overrides before affecting the useful life of the battery storage 230.

In one embodiment, the override control 222 is a mechanical or electrical button (e.g., touch-sensitive button). In another embodiment, the charge controller 220 provides the override control 222 as part of the display 130, such as via a touch screen, or via some other type of user interface as would be appreciated by one of ordinary skill in the art having the benefit of this disclosure. The override control 222 can send a signal or a message to the charge controller 220 that the user wishes to put the battery system 100 in the override mode.

In one embodiment, the charge controller 220 can use multiple DOD thresholds to allow the user to put the battery system 100 into multiple override modes, such as one mode that allows the battery system 100 until 30% depth of draw in a first mode and until 5% in a second mode. The charge controller 220 could indicate the modes in the display 130, as well as the current amount of charge remaining the respective modes. It should be noted that these percentage are merely exemplary, the charge controller 220 can be programmed to have one or more threshold values, and one or more override modes as would be appreciated by one of ordinary skill in the art having the benefit of this disclosure.

FIG. 2B illustrate another embodiment of a battery system 200 having an integrated power management system 260. The integrated power management system 260 includes interfaces configured to couple to the battery storage 230, a power source 210, one or more user interface device(s) 292, and an electrical appliance 290. The power source 210 may be a photovoltaic solar panel, a power outlet in a wall, or a power outlet of a vehicle. Alternatively, other power sources may be used to charge the battery storage 230 as would be appreciated by one of ordinary skill in the art having the benefit of this disclosure. The battery storage 230 may include one or more battery cells. The integrated power management system 260 is an electronic device, such as an integrated circuit, which includes memory 268, processing device 272, power source interface 274, battery storage interface 276, data storage 280, user interfaces 262, and an inverter 264.

Like the inverter 240, the inverter 264 is an electrical device that converts the DC provided by the battery storage 230 to an electrical appliance 290 that is plugged into the battery system 200. The electrical appliance 290 may be any type of electrical device that can be powered by the battery system 200. The battery system 200 may be a primary source of power or a secondary, back-up source of power. The inverter 240 can convert the DC to AC at any required voltage and frequency with the use of appropriate transformers, switching, and control circuits. The functionality and configurations of inverters would be appreciated by one of ordinary skill in the art, and thus, additional description regarding the functionality and configuration of inverters has not been included. In one embodiment, the inverter 240 is a 2500-Watt AC sine wave inverter, and can support surges of up to 5000 Watts. Alternatively, the inverter 240 may be other types of inverters and can support surges of other values as would be appreciated by one of ordinary skill in the art having the benefit of this disclosure. Unlike the charge controller 220 of FIG. 2A, which is separate from the DC to AC inverter 240, the integrated power management system 260 integrates the charge controller functionality and the inverter 264 into a single device. This may help the battery system 200 provide more stability and reliability to the battery system's operation. This integration may also allow easier installation and easier maintenance than systems with separate components.

The processing device 272 represents one or more general-purpose processing devices such as a microprocessor, central processing unit, or the like. More particularly, the processing device 272 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute the processing logic (e.g., battery override 226 and/or charge control 270) for performing the operations and steps discussed herein. In the depicted embodiment, the processing device 272 executes instructions for the battery override 266 and/or charge control 270 that are stored in the memory 268 to perform the operations of controlling the charging and discharging of the battery storage 230. Alternatively, these instructions may be stored in the data storage 280. The data storage 280 may also be used to store battery data 282, such as manufacturing information, monitored data, or other data needed for operation of the integrated power management system 260. In another embodiment, the integrated power management system 260 includes a charge controller, like the charge controller 220 described above with respect to FIG. 2A, and the inverter 264 in a single device. In another embodiment, the integrated power management system 260 is implemented as a microcontroller having an integrated inverter. Alternatively, the integrated power management system 260 may include more or less components as described with respect to FIG. 2B.

In one embodiment, the processing device 272 receives power from the power source 210 via the power source interface 274, and, when appropriate, stores the power in the battery storage 230 via the battery storage interface 276. The power source interface 274 may also have AC to DC conversion when the power source 210 is an AC power source. When the battery storage 230 is charged, the processing device 272 can disconnect the battery storage 230 from the connection to the power source 210 using the power source interface 274 and/or the battery storage interface 276. The processing device 272 may also use the battery storage interface 276 to disconnect the battery storage 230 from the inverter 264 when preventing the battery storage 230 from discharging further, such as when the SOC reaches the set DOD as described herein. A user of the battery system 200 can control the integrated power management system 200 using one or more user interface devices 292, such as buttons, keypads, touchpads, touchscreens, or other user interface devices. The user interface devices 292 may also include one or more displays that can indicate the status, the mode, the SOC, the DOD, or other parameters of the integrated power management system 200 to the user. The user interface devices 292 communicate with the processing device 272 and other components of the system 260 via the user interfaces 262.

In one embodiment, the integrated power management system 260 adopts an integrated, dynamic management mode that can be used to control both the charging and the discharging of the battery storage 230. The integrated power management system 260 can operate in one or more charging modes, and one or more discharging modes. The integrated power management system 260 can be used to monitor the battery system's 200 performances, such as by sampling the voltage and the battery storage's capacity. In one embodiment, the integrated power management system 260 charges the battery storage 230 using pulse charging, which dynamically controls the charge current used to charge the battery storage. For example, as the battery storage 230 is closer to being fully charged, the integrated power management system 260 reduces the charge current accordingly. This may be done to prevent over-charging of the battery storage 230, thus, effectively protecting the battery storage 230. During discharge, the integrated power management system 260 can detect the load power and dynamically set the protection voltage to prevent over discharging of the battery storage 230, according to the load power. Normally, the system's protection voltage is a solid value, as described above. The integrated power management system 260 can be used to provide a dynamic protection voltage. For example, when the output starts discharging when the load power is 1000 W, the battery's protection voltage may be set to approximately 20.5V, and when the load power is 2000 W, the battery's protection voltage is set at approximately 19.5V. In one embodiment, in order to prevent the battery from over discharging when there is large power load or when there is not enough battery capacity, the integrated power management system 260 can determine whether there is enough battery capacity in the battery storage 230 or the load power is too big (which infers lowering the voltage) and can cut the output power (e.g., by decoupling the inverter 264 from the battery storage 230) when the battery storage's voltage is smaller than the protection voltage. Thus, the integrated power management system 260 can be used to intelligently protect the battery based on the battery storage's capacity and the power load placed on the battery storage. These operations may be performed in response to the processing device 272 executing the instructions of the charge control 270 stored in memory 268.

In another embodiment, the integrated power management system 260 can execute instructions to perform the battery override 266 as described herein. These instructions may be performed in addition to, or in place of, the charge control 270. For example, in one embodiment, the battery override 266 can be implemented in a system that does not perform intelligent charge control of the charging and discharging of the battery storage 230. In another embodiment, the system performs both charge control 270 and battery override 266. The battery override 266 allows the dynamic control of the discharging of the battery storage 230 in certain circumstances. In some scenarios, a user may wish to maximize the usage of the battery storage 230. When enabled, the battery override 266 can allow the processing device 272 to adjust the dynamic protection of the battery storage 230, according to the size of the load, consequently increasing the battery capacity of the battery storage 230. In one embodiment, the battery override 266 can be enabled by a switch, a button, or other control on one of the user devices 292 via the user interface 262. For example, when an override button is pressed, the button (or other display element) can be lit up by the integrated power management system 260, and the integrated power management system 260 can adjust the dynamic control of the discharging of the battery storage 230. When the user presses the override button again, the integrated power management system 260 can turn off the light of the button (or other display element), and the integrated power management system 260 can return to normal operation. In another embodiment, the integrated power management system 260 can include multiple modes, such as a first mode that allows the user to extend the battery capacity by a first amount and a second mode that allows the user to extend the battery capacity by an additional amount or a second amount.

The integrated power management system 260 may be used as a battery-based generator that offers high integration and adopts a dynamic management scheme that protects over charging and over discharging, but also allows flexibility to extend the battery's capacity under certain circumstances. The integrated power management system 260 may be used to get maximum results from a small capacity battery driven with large load settings.

In one embodiment, the battery system 200 includes the integrated power management system 260 for charge/discharge and output control and conversion (integrated inverter 264), a discharge outlet, which coupled to the inverter 264, into which the electrical appliance 290 plugs, the battery storage 230, which is coupled to the integrated power management system 260, a charge outlet to be coupled to a solar PV panel, a charge outlet to be coupled to an AC power source, and a housing having one or more inner bracket frames or mounts to secure these components within the housing. Alternatively, the battery system 200 may include more or fewer components as described above as would be appreciated by one of ordinary skill in the art having the benefit of this disclosure.

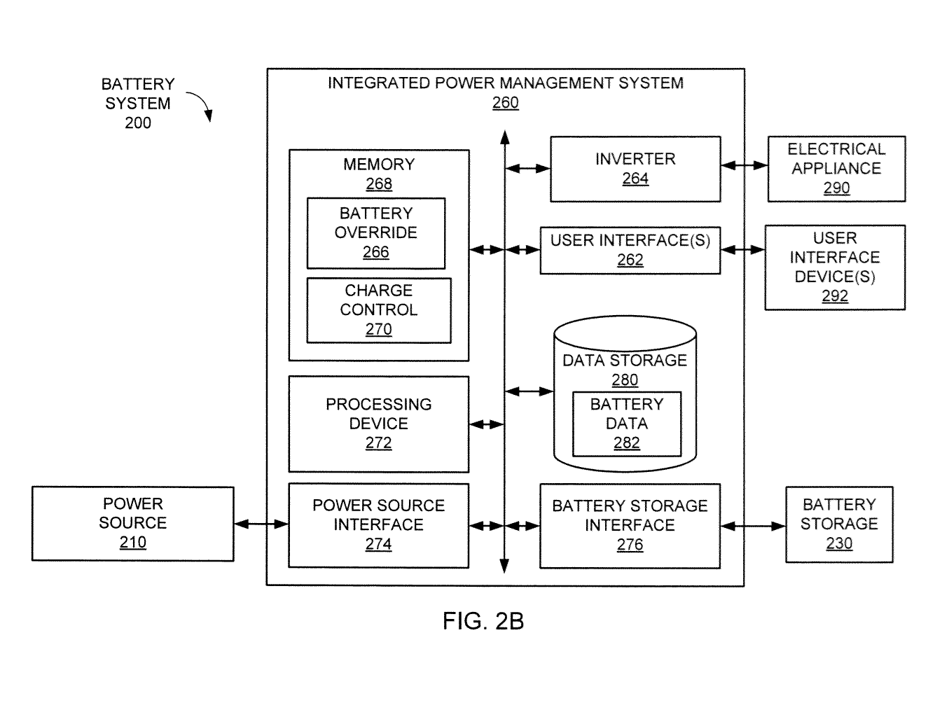

FIG. 3 is a flow diagram of one embodiment of a method 300 of overriding a depth of draw threshold of a battery system. The method 300 is performed by processing logic that may include hardware (circuitry, dedicated logic, or the like), software (such as is run on a general purpose computer system or a dedicated machine), firmware (e.g., embedded software), or any combination thereof. In one embodiment, the battery system 100 of FIGS. 1, 2A, and 2B performs the method 300. In another embodiment, the charge controller 220 performs the method 300. In another embodiment, the integrated power management system 260 performs the method 300. In another embodiment, some of the operations of the methods may be performed by other components of the battery system 100 of FIGS. 1, 2A, and 2B.

In FIG. 3, processing logic starts by monitoring a SOC of a battery system having battery storage that provides power to an electronic device (block 302). Next, the processing logic determines if the SOC meets or exceeds an initial DOD threshold (block 304). If not, the processing logic continues monitoring the SOC at block 302. When the processing logic determines that the SOC meets or exceeds the initial DOD at block 304, the processing logic determines if an override control has been activated by a user (block 306), such as if the charge controller or integrated power management system has received a signal or message from the battery override control. It should be noted that the user may activate the battery override before of after the SOC meets or exceeds the initial DOD as determined at block 304. If the battery override has been activated, processing logic sets a new DOD threshold that is lower than the initial DOD threshold to allow the battery storage to continue to provide power to the electronic device (block 308), and monitors the SOC based on the new DOD threshold (block 310). However, if at block 306, the processing logic determines that the battery override has not been activated, the processing logic prevents the battery storage from further discharge (block 312), e.g., prevents the battery storage from providing power to the electronic device being powered by the battery system, such as by preventing the inverter from outputting power to the electronic device.

While monitoring the SOC based on the new DOD threshold, the processing logic determines if the SOC meets or exceeds the new DOD threshold (block 314). If the SOC does not meet or exceeds the new DOD threshold at block 314, the processing logic continues to monitor the SOC at block 310. However, if the processing logic determines that the SOC meets or exceeds the new DOD threshold at block 304, the processing logic prevents further discharge of the battery storage (block 312), and the method 300 ends. As described above, the processing logic can prevent the battery storage from providing power to the electronic device being powered by the battery system, such as by preventing the inverter from outputting power to the electronic device.

In another embodiment, at block 314, the method may further determine if a second override control has been received, and, if so, the processing logic can set a third DOD threshold that is lower than the initial and new thresholds, and the process can repeat. The processing logic can determine how many times a new threshold can be set, and the corresponding thresholds of each of the override modes as described herein.

In one embodiment, the processing logic monitors the SOC by calculating an amount of charge remaining in the battery storage based on the initial DOD threshold or based on the new threshold, depending on whether the method is in override, and by comparing the amount of charge remaining against the initial or new DOD threshold.

In another embodiment, the processing logic displays an indication of the SOC to the user, and when a new amount of charge remaining is calculated in the override mode, the processing logic updates the display according, displaying the amount of charge remaining based on the new threshold.

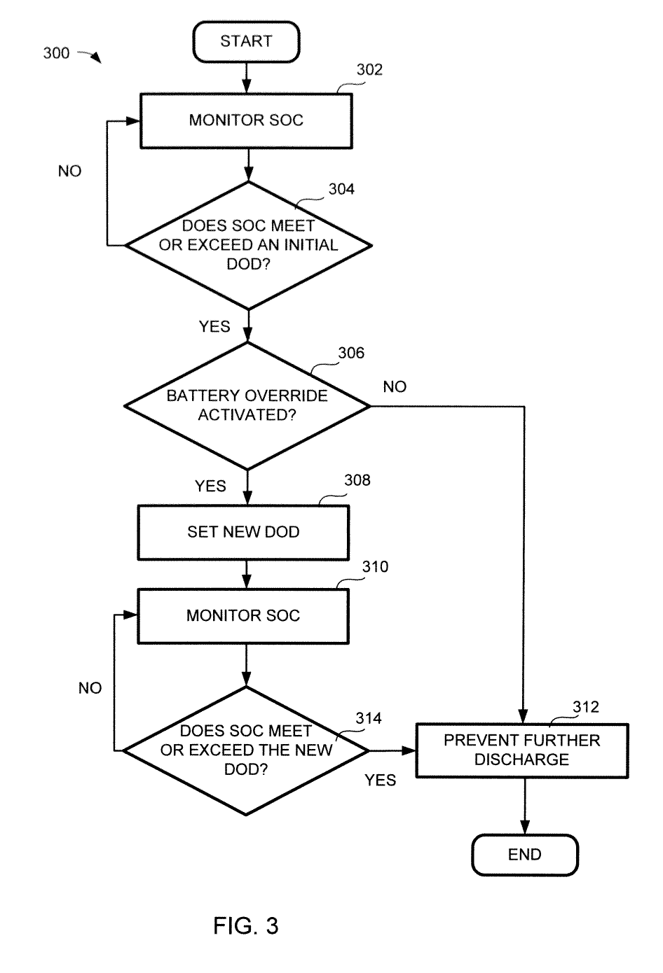

FIG. 4 illustrates a diagrammatic representation of a machine in the exemplary form of a computer system 400 for battery override according to one embodiment. Within the computer system 400 is a set of instructions for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a PC, a tablet PC, a STB, a PDA, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as the method 300 described above. In one embodiment, the computer system 400 represents various components that may be implemented in the battery system 100, the charge controller 220, and/or the integrated power management system 260 of FIGS. 1, 2A, and 2B as described above. Alternatively, the battery system 100, the charge controller 220, and/or the integrated power management system 260 may include more or less components as illustrated in the computer system 400.

The exemplary computer system 400 includes a processing device 402, a main memory 404 (e.g., read-only memory (ROM), flash memory, dynamic random access memory (DRAM) such as synchronous DRAM (SDRAM) or DRAM (RDRAM), etc.), a static memory 406 (e.g., flash memory, static random access memory (SRAM), etc.), and a data storage device 416, each of which communicate with each other via a bus 430.

Processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute the processing logic (e.g., battery override 426) for performing the operations and steps discussed herein.

The computer system 400 may further include a network interface device 422. The computer system 400 also may include a display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 416 may include a computer-readable storage medium 424 on which is stored one or more sets of instructions (e.g., battery override 426) embodying any one or more of the methodologies or functions described herein. The battery override 426 may also reside, completely or at least partially, within the main memory 404 and/or within the processing device 402 during execution thereof by the computer system 400, the main memory 404 and the processing device 402 also constituting computer-readable storage media. The battery override 426 may further be transmitted or received over a network via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, or other types of mediums for storing the instructions. The term “computer-readable transmission medium” shall be taken to include any medium that is capable of transmitting a set of instructions for execution by the machine to cause the machine to perform any one or more of the methodologies of the present embodiments.

The battery override module 432, components, and other features described herein (for example in relation to FIGS. 1, 2A, 2B, and 3) can be implemented as discrete hardware components or integrated in the functionality of hardware components such as ASICS, FPGAs, DSPs or similar devices. In addition, the battery override module 432 can be implemented as firmware or functional circuitry within hardware devices. Further, the battery override module 432 can be implemented in any combination hardware devices and software components.

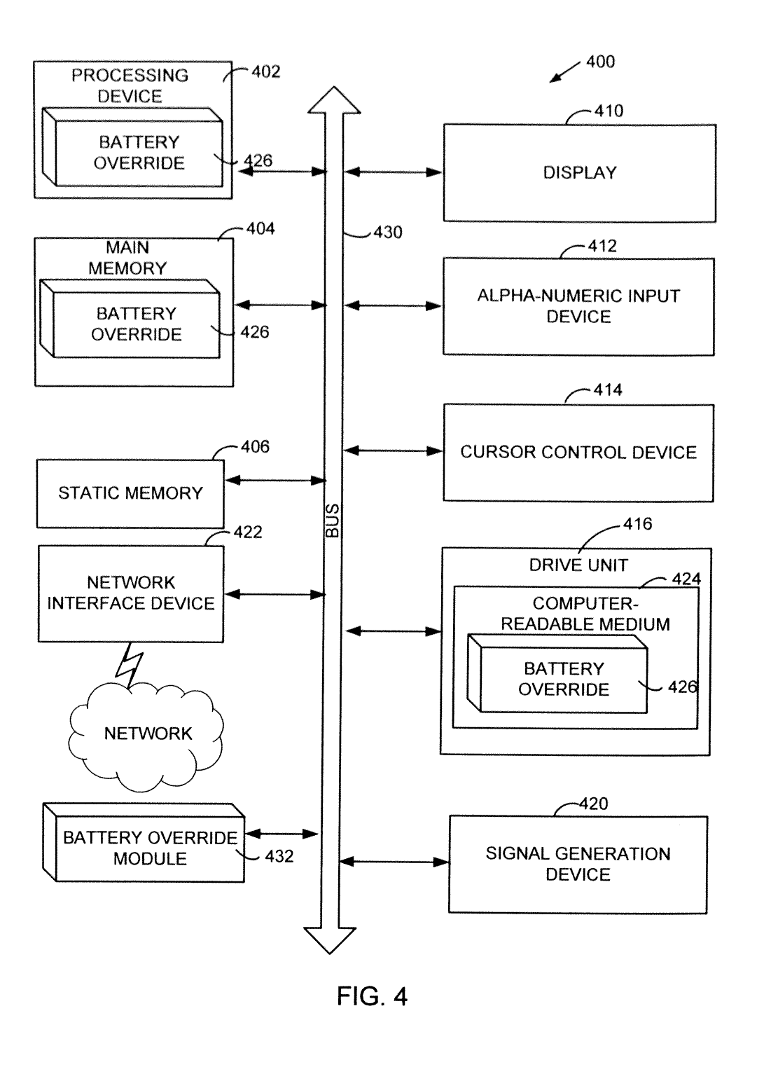

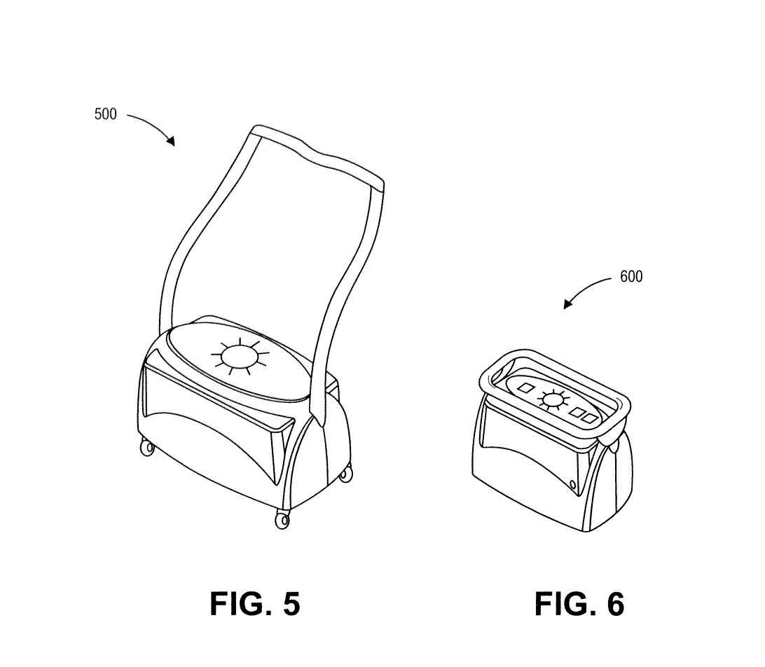

FIG. 5 illustrates one embodiment of a battery system 500 having a handle and wheels. The handle and wheels allow for easy portability of the battery system 500. FIG. 6 illustrates another embodiment of a battery system 600 having a handle. The handles and wheels of the battery systems 500 and 600 may be used for portability of the units. In one embodiment, the battery systems 500 and 600 are self-contained systems, having approximately 1320 total Watt-hours of storage and a 2500-Watt AC sine wave inverter, and can support surges of up to 5000 Watts. Each of the battery systems 500 and 600 has an outlet to allow a 30-watt solar panel to be connected to the battery system 500 using a cable. The battery systems 500 and 600 are designed for daily or sporadic usage, and offers quick-charge options, such as by plugging the battery system 500 or 600 into an AC source or a 12V DC source such as a car power outlet. The battery system 500 or 600 also includes an LCD display that shoes the available battery charge. The battery systems 500 and 600 may each include a switch to turn the system on or off. The battery systems 500 and 600 may each be used as a solar generator that captures power with the solar panel and stores the power in battery storage, making the power available for anyone to plug in their electric appliances and equipment. The battery systems 500 and 600 may use a standard photovoltaic solar panel that can be placed on the roof, the porch, the yard, or anywhere that has good exposure to the sun. The battery system 500 and 600 may each include a charge control system (e.g., charge controller 220 or integrated power management system 260) to maximize the life and effectiveness of deep-cycle, sealed lead-acid batteries. The battery systems 500 and 600 are not like traditional gasoline or diesel generators because you do not need to put fuel into it, adjust a chock control, pull a cord to get it started, or worry about storing flammable and smelly fuels. In addition, unlike traditional gasoline or diesel generators, the battery system 500 and 600 are virtually noise-free. Internal fans may turn on to circulate air through the system's power inverter from time to time, but this noise may be significantly less than a gasoline or diesel generator. Furthermore, the embodiments described herein generate no emissions. The internal batteries are sealed, and thus, you can use the battery system 500 and 600 indoors.

Embodiments of the present invention, described herein, include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain portions of the embodiments may be implemented as a computer program product that may include instructions stored on a computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions. The computer-readable transmission medium includes, but is not limited to, electrical, optical, acoustical, or other form of propagated signal (e.g., carrier waves, infrared signals, digital signals, or the like), or another type of medium suitable for transmitting electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will be evident, however, that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method, implemented by a processing device programmed to perform operations, comprising:
monitoring a state of charge (SOC) of a battery system comprising battery storage to provide power to an electronic device;
determining if the SOC meets or exceeds an initial depth of draw (DOD) threshold;
when the SOC meets or exceeds the initial DOD threshold, determining if an override control has been received from a user; and
when the override control has been received, setting a new DOD threshold that is lower than the initial DOD threshold to allow the battery storage to continue to provide power to the electronic device.

2. The method of claim 1, further comprising preventing the battery storage from providing power to the electronic device when the override control has not been received and the SOC meets or exceeds the initial DOD threshold.

3. The method of claim 1, wherein said monitoring comprises:
calculating an amount of charge remaining in the battery storage based on the initial DOD threshold; and
comparing the amount of charge remaining against the initial DOD threshold.

4. The method of claim 3, further comprising displaying the amount of charge remaining in the battery storage to the user.

5. The method of claim 4, further comprising monitoring the SOC of the battery system based on the new DOD threshold when the override control has been received from the user.

6. The method of claim 5, wherein said monitoring comprises:
calculating a new amount of charge remaining in the battery system based on the new DOD threshold; and
comparing the new amount of charge remaining against the initial DOD threshold.

7. The method of claim 6, further comprising displaying the new amount of charge remaining in the battery storage to the user.

8. The method of claim 5, further comprising:
determining that the SOC meets or exceeds the new DOD threshold; and
when the SOC meets or exceeds the new DOD threshold, preventing the battery storage from providing power to the electronic device.

9. The method of claim 5, further comprising:
determining that the SOC meets or exceeds the new DOD threshold;
when the SOC meets or exceeds the new DOD threshold, determining if a second override control has been received from the user; and
when the second override control has been received, setting a third DOD threshold that is lower than the new DOD threshold to allow the battery storage to continue providing power to the electronic device.

10. The method of claim 9, further comprising monitoring the SOC of the battery system based on the third DOD threshold when the second override control has been received from the user.

11. A battery system, comprising:
a battery storage to provide power to an electronic device; and
a charge controller coupled to the battery storage, wherein the charge controller is configured to monitor a state of charge (SOC) of the battery storage, and determine if the SOC meets or exceeds an initial depth of draw (DOD) threshold, when the charge controller determines that the SOC meets or exceeds the initial DOD threshold, the charge controller is configured to determine if an override control has been received from a user, and when the override control has been received, the charge controller is further configured to set a new DOD threshold that is lower than the initial DOD threshold to allow the battery storage to continue providing power to the electronic device.

12. The battery system of claim 11, further comprising:
a direct current (DC) to alternating current (AC) inverter coupled to the charge controller, wherein the DC to AC inverter is configured to convert the DC power supplied by the battery storage to AC power that is supplied to the electronic device; and
a display coupled to the charge controller, wherein the charge controller is configured to display an amount of charge remaining in the battery storage and a new amount of charge remaining in the battery storage when in override.

13. The battery system of claim 11, further comprising an override control coupled to the charge controller, wherein the override control sends an override control signal to initiate an override mode of the charge controller when activated by the user.

14. The battery system of claim 11, wherein the battery system is coupled to a power source configured to charge the battery storage of the battery system.

15. The battery system of claim 11, wherein the battery system is coupled to a photovoltaic solar panel, wherein the photovoltaic solar panel is configured to charge the battery storage of the battery system.

16. The battery system of claim 11, further comprising an inverter configured to convert direct current (DC) power supplied by the battery storage to alternating current (AC) power that is supplied to the electronic device, and wherein the charge controller and the inverter are integrated into a single device.

17. A computer-readable storage medium storing instruction thereon when executed by a processing device cause the processing device to perform a method, comprising:
monitoring a state of charge (SOC) of a battery system comprising battery storage to provide power to an electronic device;
determining if the SOC meets or exceeds an initial depth of draw (DOD) threshold;
when the SOC meets or exceeds the initial DOD threshold, determining if an override control has been received from a user; and
when the override control has been received, setting a new DOD threshold that is lower than the initial DOD threshold to allow the battery storage to continue to provide power to the electronic device.

18. The computer-readable storage medium of claim 17, wherein the method further comprises preventing the battery storage from providing power to the electronic device when the override control has not been received and the SOC meets or exceeds the initial DOD threshold.

19. The computer-readable storage medium of claim 17, wherein said monitoring comprises:
calculating an amount of charge remaining in the battery storage based on the initial DOD threshold; and
comparing the amount of charge remaining against the initial DOD threshold.

20. The computer-readable storage medium of claim 19, further comprising displaying the amount of charge remaining in the battery storage to the user.

21. The computer-readable storage medium of claim 20, further comprising:
calculating a new amount of charge remaining in the battery system based on the new DOD threshold;
comparing the new amount of charge remaining against the initial DOD threshold; and
displaying the new amount of charge remaining in the battery storage to the user.

22. A battery system, comprising:
a battery storage comprising one or more deep-cycle battery cells configured to store power for providing electricity to an electronic device to be coupled to the battery system; and
an integrated power management system coupled to the battery storage and to be coupled to a power source, wherein the integrated power management system comprises:
a processing device configured to execute one or more instructions to dynamically control charging and discharging of the battery storage by the power source; and
an inverter to convert direct current (DC) power received from the battery storage into alternating current (AC) power to provided to the electronic device when coupled to the battery system, wherein the inverter is integrated with the processing device into the integrated power management system as a single device.

23. The battery system of claim 22, wherein the processing device is further configured to execute one or more instructions to provide a battery override to extend a battery capacity of the battery storage when providing electricity to the electronic device and when activated by a user.

24. The battery system of claim 22, further comprising the power source, wherein the power source is at least one of a solar panel, a wall outlet, or a vehicle outlet.
